(19) United States
(12) Patent Application Publication
(10) Pub. No.: US 2025/0358918 A1
(43) Pub. Date: Nov. 20, 2025

(54) LIGHTING FIXTURE AND LIGHTING SYSTEM

(71) Applicant: Panasonic Intellectual Property Management Co., Ltd., Osaka (JP)

(72) Inventors: Shigeo GOTOH, Osaka (JP); Tomomi HASHIMOTO, Kyoto (JP)

(21) Appl. No.: 19/191,703

(22) Filed: Apr. 28, 2025

(30) Foreign Application Priority Data
May 15, 2024 (JP) 2024-079575

(51) Int. Cl. H05B 47/115

(52) U.S. Cl. CPC H05B 47/115

(57) ABSTRACT

A lighting fixture includes: a light source; a communicator that receives (i) a first detection signal indicating that a person is detected in a target area and (ii) a second detection signal, among a plurality of second detection signals, indicating that a person is detected in an area other than the target area among the plurality of areas; and a controller that (a) controls the light source in a first dimming state when the first detection signal is received, and (b) maintains the first dimming state when, in a case where all of the plurality of lighting fixtures are in the first dimming state, a second detection signal indicating that a person is detected in a first area is received, and, during a most recent predetermined period, a second detection signal indicating that a person is detected in a second area is received.

### CROSS REFERENCE TO RELATED APPLICATION

This application claims the benefit of priority of Japanese Patent Application Number 2024-079575, filed on May 15, 2024, the entire content of which is hereby incorporated by reference.

### TECHNICAL FIELD

The present disclosure relates to a lighting fixture and a lighting system.

### BACKGROUND ART

Regarding lighting control, a technique has been disclosed in which the brightness of lighting is gradually made darker when it is detected that people are no longer present in order to prevent a lighting fixture from being turned off even though there is a person still present in a lighting area (see Japanese Unexamined Patent Application Publication No. 2005-108703 (Patent Literature (PTL) 1), for example).

### SUMMARY

However, although the technique disclosed in PTL 1 describes how to illuminate an area in which a person is present, the technique does not describe how to illuminate areas in which people are not present that are in a vicinity of the area in which the person is present. For this reason, there is a problem that the person will feel unsafe when moving in an indoor space since the areas in which people are not present will remain dark.

In view of this, the present disclosure has an object to provide a lighting fixture and a lighting system that can perform dimming control of lighting in a manner such that a user can feel safe while the user is active in an indoor space.

A lighting fixture according to one aspect of the present disclosure is one of a plurality of lighting fixtures each of which emits light in a different one of a plurality of areas included in a space, and the lighting fixture includes: a light source; a communicator that receives (i) a first detection signal indicating that a person is detected in a target area that is a target to be illuminated by the light of the lighting fixture and (ii) a second detection signal, among a plurality of second detection signals, indicating that a person is detected in an area other than the target area among the plurality of areas; and a controller that (a) controls the light source in a first dimming state when the first detection signal is received, and (b) maintains the first dimming state when, in a case where all of the plurality of lighting fixtures are in the first dimming state, a second detection signal, among the plurality of second detection signals, indicating that a person is detected in a first area other than the target area is received, and, during a most recent predetermined period, a second detection signal, among the plurality of second detection signals, indicating that a person is detected in a second area other than the first area is received.

Furthermore, one aspect of the lighting system according to the present disclosure includes the lighting fixture described above and a plurality of sensors that detect whether a person is present.

The lighting fixture and the lighting system according to the present disclosure can perform dimming control of lighting in a manner such that a user can feel safe while the user is active in an indoor space.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram illustrating a functional configuration of a lighting system according to an embodiment.

FIG. 2 is a diagram illustrating an example of an arrangement of lighting fixtures and sensors in the lighting system according to the embodiment.

FIG. 3 is a schematic diagram of a communication network of the lighting system according to the embodiment.

FIG. 4 is a diagram illustrating operation of the lighting system according to the embodiment.

FIG. 5 is a flowchart illustrating the flow of operation of the lighting fixtures according to the embodiment.

### DETAILED DESCRIPTION

Hereinafter, embodiments of a lighting fixture and a lighting system, and the like, according to the present disclosure will be described in detail with reference to the drawings. It should be noted that the embodiments described below each illustrate a specific example of the present disclosure. The numerical values, the arrangement and connection states of the elements, steps, the order of the steps, etc., described in the following embodiments are mere examples, and are therefore not intended to limit the present disclosure. Accordingly, among elements in the following embodiments, those not appearing in any of the independent claims will be described as optional elements of an embodiment.

It should be noted that the respective figures are schematic diagrams and are not necessarily precise illustrations. Furthermore, in the respective figures, elements that are substantially the same are given the same reference signs, and redundant descriptions may be omitted or simplified.

### Embodiment

### [Configuration]

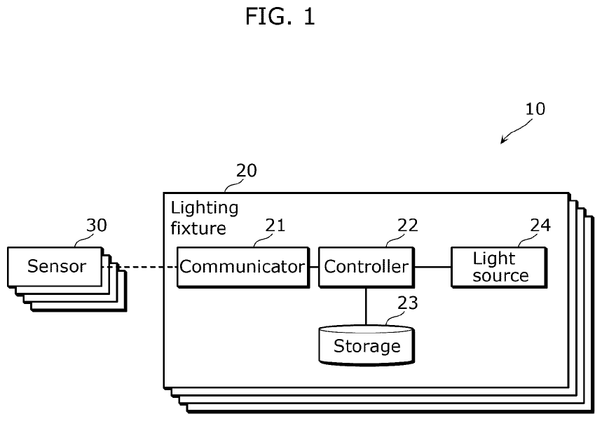

First, a configuration of a lighting system according to an embodiment will be described. FIG. 1 is a block diagram illustrating a functional configuration of lighting system 10 according to an embodiment. As illustrated in FIG. 1, lighting system 10 includes a plurality of lighting fixtures 20 and a plurality of sensors 30. The total number of the plurality of lighting fixtures 20 and the total number of the plurality of sensors 30 included in lighting system 10 are not particularly limited.

Lighting system 10 is a system for illuminating an indoor space. The indoor space is, for example, an office. A user of lighting system 10 is, for example, a person who works at the office in which lighting system 10 is provided.

Lighting fixture 20 is a lighting fixture that is provided in a ceiling of the indoor space, and illuminates the indoor space. Lighting fixture 20 is implemented as a base light, for example. Lighting fixture 20 is not particularly limited to this aspect, and may be a ceiling light, a down light, a spot light, or the like. Lighting fixture 20 specifically includes communicator 21, controller 22, storage 23, and light source 24.

Communicator 21 is a communication circuit (communication module) for lighting fixture 20 for communicating with the plurality of sensors 30. The communication standard for communication performed by communicator 21 is, for example, wireless communication, such as BLE (Bluetooth (registered trademark) Low Energy), Wi-Fi (registered trademark), Zigbee (registered trademark), or the like, but may be wired communication. Communicator 21 may perform wired communication with one sensor 30, while performing wireless communication with the other remaining sensors 30. The communication standard for communication performed by communicator 21 is not particularly limited.

Controller 22 performs light-emission control of lighting fixture 20 (light source 24). Light-emission control is control, such as control to turn on, control to turn off, dimming control, color adjustment control, light distribution control, and the like. Controller 22 is, for example, implemented as a microcomputer, but may be implemented as a processor or a dedicated circuit. The functionality of controller 22 is, for example, implemented as hardware, such as a microcomputer or a processor or the like that includes controller 22 executing a computer program (software) stored in storage 23.

Storage 23 is a storage device in which a computer program executed by controller 22, and the like, are stored. Storage 23 is implemented as semiconductor memory or the like, for example.

Light source 24 emits white light in the indoor space, thereby allowing lighting fixture 20 to illuminate the indoor space. Light source 24 is, for example, implemented as a light-emitting diode (LED) element, but may be implemented as other light-emitting elements, such as a semiconductor laser, an organic electro-luminescence (EL) element, an inorganic EL element, or the like.

Sensor 30 detects a person present in the indoor space, and is a sensor that has a function to transmit a detection signal indicating that a person is detected to lighting fixture 20. Sensor 30 is, for example, implemented as a human sensor. The human sensor is a pyroelectric sensor (infrared sensor) that detects infrared rays emitted from a body of a person. Sensor 30 may also be implemented as an image sensor (camera) that captures an image of the indoor space. Sensor 30 may also be implemented as a radio-wave sensor. Sensor 30 is not particularly limited as long as it is a sensor that can detect a magnitude of movement.

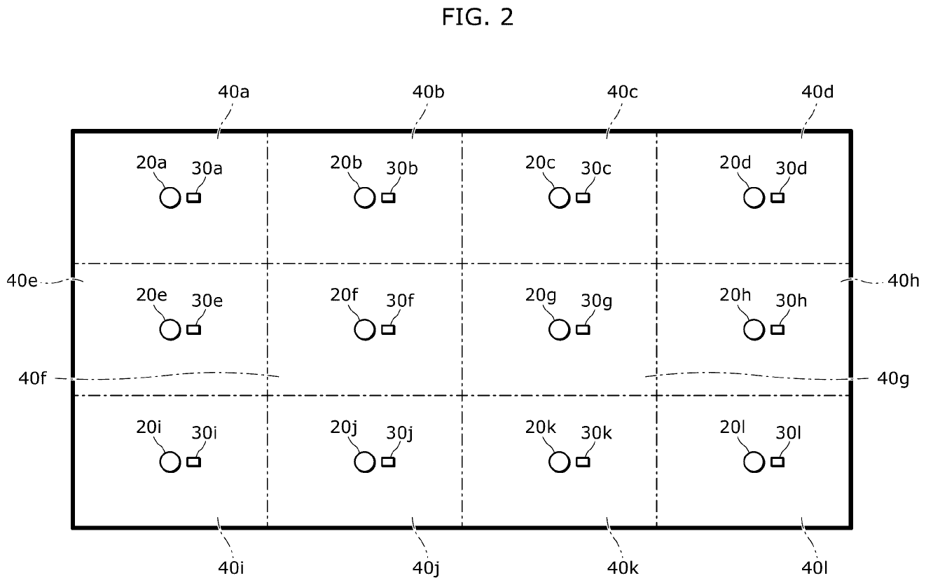

Next, an arrangement of the plurality of lighting fixtures 20 and the plurality of sensors 30 in lighting system 10 according to the embodiment will be described. FIG. 2 is a diagram illustrating an example of an arrangement of lighting fixtures 20 and sensors 30 in lighting system 10 according to the embodiment.

As illustrated in FIG. 2, the indoor space is divided into a plurality of areas 40, and a single pair of lighting fixture 20 and sensor 30 is provided in each area, for example. In FIG. 2, the indoor space is specifically divided into 12 areas, namely, area 40a through area 40l. For example, in area 40a, lighting fixture 20a emits light and sensor 30a performs sensing.

It should be noted that in one of areas 40, a plurality of sensors 30 may be provided, and in one of areas 40, a plurality of lighting fixtures 20 may be provided. As long as area 40 is associated with a sensor 30 that performs sensing, and area 40 is associated with a lighting fixture 20 that emits light, the total number of lighting fixtures 20 and the total number of sensors 30 are not particularly limited.

Essentially, lighting fixture 20 that is provided in a given area 40 emits light in the given area 40 when a detection signal indicating that a person is detected by a given sensor 30, which is provided in the given area 40, is received from the given sensor 30. In lighting system 10, lighting fixture 20 provided in a given area 40 receives a detection signal transmitted by a sensor 30 provided in another area 40, and monitors a detection result of the sensor 30 in the other area 40.

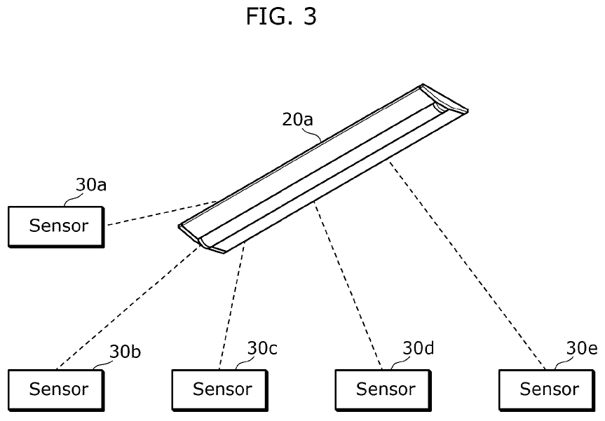

Hereinafter, a communication network in such a lighting system 10 will be described. FIG. 3 is a schematic diagram of a communication network of lighting system 10 according to the embodiment. As illustrated in FIG. 3, lighting fixture 20a (provided in area 40a) communicates with sensor 30a (sensor associated with lighting fixture 20a) provided in area 40a. Sensor 30a being “associated with” lighting fixture 20a indicates that the area illuminated by lighting fixture 20a is the same area in which sensor 30a performs sensing.

Furthermore, lighting fixture 20a also communicates with sensor 30b, sensor 30c, sensor 30d, and sensor 30e, which are not associated with lighting fixture 20a. In other words, lighting fixture 20a receives detection signals from all sensors included in lighting system 10, namely, sensor 30a through sensor 30e. In other words, sensor 30a transmits a detection signal to all lighting fixtures 20 included in lighting system 10.

Note that in FIG. 3, although it is illustrated such that a detection signal is transmitted to lighting fixture 20a from each of sensor 30a through sensor 30e, the detection signals may be transmitted in any manner. For example, the plurality of lighting fixtures 20 and the plurality of sensors 30 may be configured as a wireless mesh network, and a detection signal transmitted by a given sensor 30 may be relayed by another lighting fixture 20 or another sensor 30 or the like before being received by lighting fixture 20a.

### [Operation]

Next, operation of lighting system 10 according to an embodiment will be described. Lighting system 10 is a system that causes lighting fixture 20 to brightly emit light under a predetermined condition not only when a person is detected in a target area that is a target to be illuminated by the light of lighting fixture 20, but also when a person is detected in an area other than the target area. Such a lighting system 10 can perform dimming control of lighting in a manner such that a user can feel safe while the user is active in an indoor space.

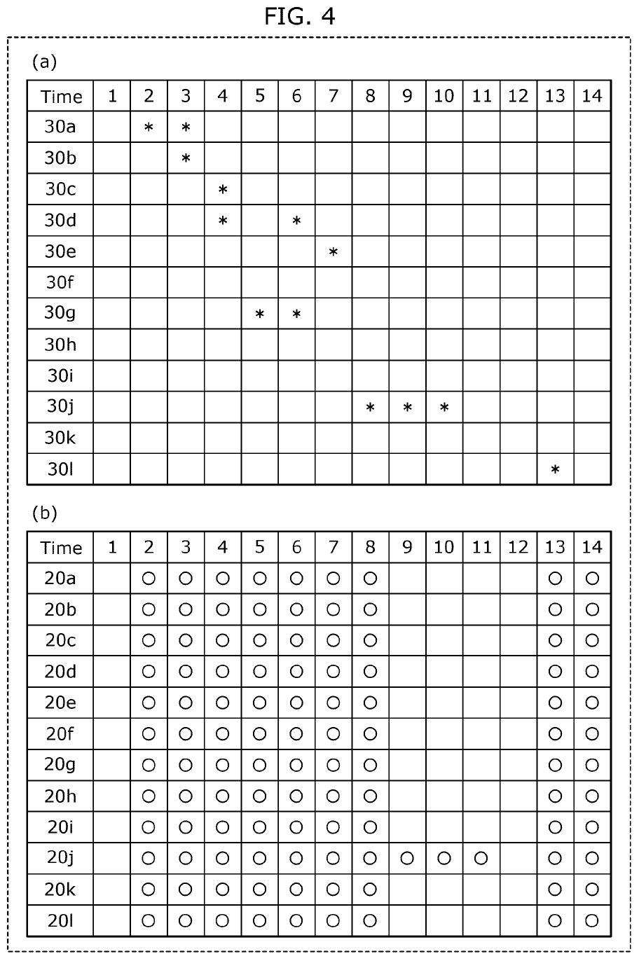

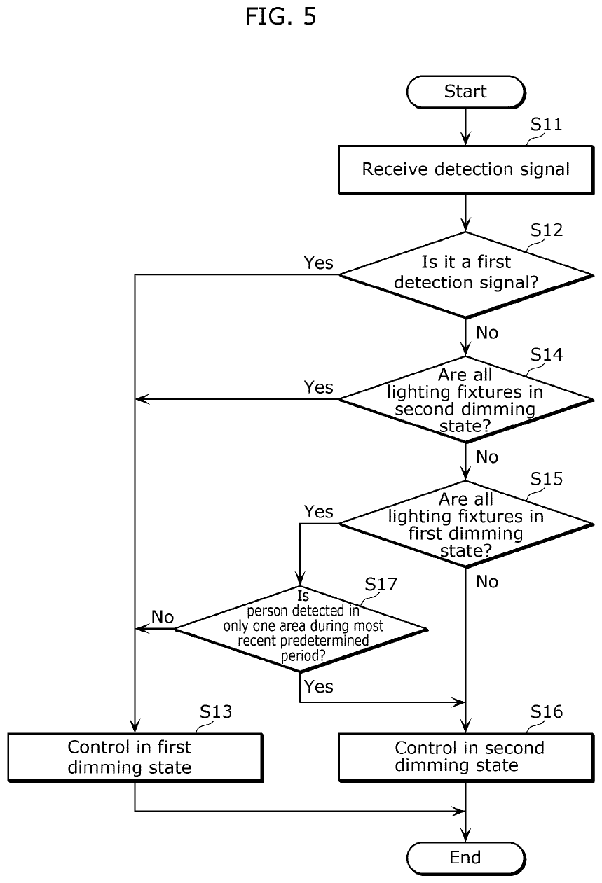

Hereinafter, operation of such a lighting system 10 will be described with reference to FIG. 4 and FIG. 5 in addition to FIG. 2. FIG. 4 is a diagram illustrating operation of lighting system 10 according to the embodiment. (a) in FIG. 4 is a diagram illustrating operation of sensors 30 in lighting system 10 according to the embodiment. (b) in FIG. 4 is a diagram illustrating operation of lighting fixtures 20 in lighting system 10 according to the embodiment.

(a) in FIG. 4 indicates whether a person is detected at a given time by each of sensor 30a through sensor 30l that are provided to perform sensing in each of area 40a through area 40l, as illustrated in FIG. 2. The symbol “*” in (a) in FIG. 4 indicates that a person is detected by one of sensors 30. For example, at time “3”, it is indicated that a person is detected by sensor 30a and sensor 30b.

(b) in FIG. 4 indicates a dimming state at a given time for each of lighting fixture 20a through lighting fixture 20l provided to illuminate each of area 40a through area 40l, as illustrated in FIG. 2. The circular symbols in (b) in FIG. 4 indicate that lighting fixture 20 is in a first dimming state (dimming state that is bright). The empty fields in (b) in FIG. 4 indicate that lighting fixture 20 is in a second dimming state (dimming state that is darker than the first dimming state). For example, at time “9”, it is indicated that lighting fixture 20j is in the first dimming state, and that lighting fixture 20a through lighting fixture 20i, lighting fixture 20k, and lighting fixture 20l are in the second dimming state. Furthermore, the “time” indicated in (a) in FIG. 4 and the “time” indicated in (b) in FIG. 4 indicate the same time.

At time “1” in FIG. 4, lighting fixture 20a through lighting fixture 20l are all in the second dimming state (dimming state that is dark). At time “2”, when a user enters area 40a in the indoor space from outside of the indoor space, sensor 30a detects the user, and transmits detection signals to lighting fixture 20a through lighting fixture 20l. As a result, lighting fixture 20a through lighting fixture 20l emit light in the first dimming state.

At time “2”, and subsequently, at time “3” through time “7”, sensor 30a through sensor 30e, sensor 30g, and the like detect the user due to movement and the like of the user in the indoor space, and transmit detection signals to lighting fixture 20a through lighting fixture 20l. During this time, lighting fixture 20a through lighting fixture 20l continue to emit light in the first dimming state.

At time “8”, the user arrives at area 40j, and if the user remains in area 40j, only sensor 30j will detect the user and transmit detection signals to lighting fixture 20a through lighting fixture 20l. The rest of sensor 30a through sensor 30i and sensor 30k through sensor 30l do not detect the user. If this state persists, only lighting fixture 20j will emit light in the first dimming state, and the other of each of lighting fixture 20a through lighting fixture 20i and each of lighting fixture 20k through lighting fixture 20l will switch to the second dimming state. In FIG. 4, in time “9” to time “11”, only lighting fixture 20j emits light in the first dimming state.

At time “11”, all of each of sensor 30a through sensor 30l stop detecting the user, and subsequently, at time “12”, all of each of lighting fixture 20a through lighting fixture 20l are emitting light in the second dimming state. At the end of time “12”, when sensor 30l starts detecting the above-mentioned user or another user, each of lighting fixture 20a through lighting fixture 20l will emit light in the first dimming state.

In this manner, in lighting system 10, when lighting fixture 20a through lighting fixture 20l are all in the second dimming state, lighting fixture 20a through lighting fixture 20l are all triggered by any one of sensor 30a through sensor 30l detecting the user to begin emitting light in the first dimming state, and when a state persists in which the user is detected by only one of sensor 30a through sensor 30l, only the area associated with the one sensor will remain in the first dimming state.

In order to implement such operation, each of lighting fixture 20a through lighting fixture 20l operates as illustrated in FIG. 5. FIG. 5 is a flowchart illustrating the flow of operation of lighting fixtures 20 according to the embodiment.

It should be noted that each of lighting fixture 20a through lighting fixture 20l, as hereinafter described in FIG. 5, manages (grasps) a current dimming state of a corresponding one of lighting fixture 20a through lighting fixture 20l (whether it is in the first dimming state or the second dimming state), and such management is performed based on the determination given in steps S14 and S15 as described below. Each of lighting fixture 20a through lighting fixture 20l manages a dimming state of a corresponding one of lighting fixture 20a through lighting fixture 201 based on detection signals received from sensor 30a through sensor 30l, for example, but may manage a dimming state of a corresponding one of lighting fixture 20a through lighting fixture 20l by periodically communicating with the corresponding one of lighting fixture 20a through lighting fixture 20l. In the following description of FIG. 5, lighting fixture 20 is a given one of lighting fixture 20a through lighting fixture 20l, and sensor 30 is a given one of sensor 30a through sensor 30l.

First, communicator 21 receives a detection signal from sensor 30 (S11 in FIG. 5). The detection signal is a signal indicating that a person has been detected as being present in a detection area that is a detection target of sensor 30. Sensor 30 transmits the detection signal to communicator 21 of lighting fixture 20 by wireless communication, for example.

Communicator 21 receives the detection signal, and controller 22 then determines whether the detection signal received is a first detection signal (S12 in FIG. 5). A first detection signal is a detection signal transmitted by the sensor 30 that is associated with lighting fixture 20. In other words, it is a detection signal indicating that a person has been detected in a target area that is a target to be illuminated by the light of lighting fixture 20. For example, since the target area that is the target to be illuminated by the light of lighting fixture 20a illustrated in FIG. 2 is area 40a, a first detection signal received by lighting fixture 20a is a detection signal that has been transmitted by sensor 30a after sensor 30a has detected a person in area 40a.

If it is determined that the detection signal received is a first detection signal (“Yes” in S12 in FIG. 5), controller 22 controls light source 24 to emit light in a first dimming state for a predetermined period (S13 in FIG. 5). The first dimming state is a state in which light source 24 emits light at a predetermined brightness. The predetermined period is, for example, three minutes. It should be noted that the predetermined period may be five minutes, and may be one minute. Here, the length of the predetermined period is not particularly limited.

If it is determined that the detection signal received is not a first detection signal (“No” in S12 in FIG. 5), or in other words, it is determined that the detection signal received is a second detection signal, controller 22 then determines whether all of lighting fixtures 20 are in the second dimming state (S14 in FIG. 5).

A second detection signal is a detection signal transmitted by the sensors 30 not associated with lighting fixture 20. In other words, it is a detection signal indicating that a person has been detected in an area 40 other than the target area that is the target to be illuminated by the light of lighting fixture 20. A second detection signal can be used to identify which of sensors 30 has transmitted the detection signal. For example, in FIG. 2, second detection signals received by lighting fixture 20a are detection signals sent by sensor 30b through sensor 30l. The second dimming state is a state in which light source 24 emits light at a brightness that is darker than the first dimming state.

If it is determined that all of lighting fixtures 20 are in the second dimming state (“Yes” in S14 in FIG. 5), controller 22 then controls light source 24 to emit light in the first dimming state (S13 in FIG. 5).

If it is determined that not all of lighting fixtures 20 are in the second dimming state (“No” in S14 in FIG. 5), controller 22 then determines whether lighting fixtures 20 are all in the first dimming state (S15 in FIG. 5).

If it is determined that not all of lighting fixtures 20 are in the first dimming state (“No” in S15 in FIG. 5), controller 22 then controls light source 24 to emit light in the second dimming state (S16 in FIG. 5). In other words, if it is determined that only a portion of lighting fixtures 20 are in the first dimming state, controller 22 then controls light source 24 to emit light in the second dimming state.

If it is determined that all of lighting fixtures 20 are in the first dimming state (“Yes” in S15 in FIG. 5), controller 22 then determines whether a person has been detected in only one area during a most recent predetermined period (S17 in FIG. 5). The most recent predetermined period is defined as a period of time extending back a predetermined period of time prior to the moment at which the detection signal was received in step S11. The most recent predetermined period includes the moment at which the detection signal was received in step S11.

If it is determined that a person or people are detected in a plurality of areas 40 during the most recent predetermined period (“No” in S17 in FIG. 5), controller 22 then controls light source 24 to emit light in the first dimming state (S13 in FIG. 5).

If it is determined that a person is detected in only one area 40 during the most recent predetermined period (“Yes” in S17 in FIG. 5), controller 22 then controls light source 24 to emit light in the second dimming state (S16 in FIG. 5).

Each of lighting fixtures 20 included in lighting system 10 repeats the processes in steps S11 to S17 in FIG. 5 each time a detection signal is received. It should be noted that each of lighting fixtures 20 may repeat the processes in steps S11 to S17 in FIG. 5 over each cycle of a period of time that is sufficiently shorter than the predetermined period.

With the above-mentioned operation, lighting fixtures 20 are controlled in the first dimming state under predetermined conditions not only in a case where a person is present in the target area, but also in a case where a person is detected in an area other than the target area. In other words, when sensor 30 detects that a user continues to move or that a plurality of users are present in the indoor space, or the like, lighting system 10 maintains all of lighting fixtures 20 in a brightly illuminated state. Consequently, the user can feel safe while the user is active in the indoor space.

### [Variations]

In the above-mentioned embodiment, although controller 22 controls light source 24 in the second dimming state that is a state that is darker than the first dimming state, when controller 22 controls light source 24 in the second dimming state, controller 22 may perform control in an off state instead of performing control in the second dimming state. In the above-mentioned embodiment, the “second dimming state” may be replaced with the “off state”. In such a lighting system 10, when it is determined that only one user that is using the indoor space is present, lighting fixtures 20 that illuminate areas in which the user is not present may be set to the off state.

In the above-mentioned embodiment, in step S17 in FIG. 5, although controller 22 determines whether a person is detected in only one area during the most recent predetermined period, the one area may be a plurality of areas instead. In other words, controller 22 may determine whether people are detected in only the plurality of areas during the most recent predetermined period. For example, when two users are using the indoor space and each of the two users remain in a different area to perform work, it is determined that people are only detected in two areas during the most recent predetermined period. Here, the total number of the plurality of areas is two, for example, but may be three, and the total number of the plurality of areas is not particularly limited. In such a lighting system 10, when it is determined that the total number of users using the indoor space is less than or equal to the predetermined total number of the plurality of areas, the lighting fixtures 20 that illuminate areas in which the users are not present may be prevented from being maintained in the first dimming state.

In the above-mentioned embodiment, in step S12 in FIG. 5, although controller 22 determines whether the detection signal is a first detection signal, controller 22 may determine whether the detection signal is a first detection signal or a predetermined second detection signal. The predetermined second detection signal is, for example, a detection signal indicating that a person has been detected as being present in an area in a vicinity of the target area that is the target to be illuminated by the light of lighting fixture 20. The area in the vicinity of the target area is, for example, an area that is adjacent to the target area. In such a lighting system 10, when a user remains in an area, control is performed such that the lighting fixture 20 that illuminates an area adjacent to the area emits light in the first dimming state. Consequently, when the user remains in a given area, the user can feel safe while performing work or the like.

Furthermore, the predetermined second detection signal may, for example, be a detection signal transmitted by a sensor 30 that performs detection in an area that includes an entrance or exit of the indoor space. Since such a lighting system 10 performs control such that all of lighting fixtures 20 emit light in the first dimming state each time a user enters or exits the indoor space, the user can feel safe while the user is active in the indoor space.

In the above-mentioned embodiment, in steps S14 and S15 in FIG. 5, each of lighting fixture 20a through lighting fixture 20l manages (grasps) current dimming states of lighting fixture 20a through lighting fixture 20l (whether they are in the first dimming state or the second dimming state). Although the dimming states of the other lighting fixtures 20 are determined based on such management, controller 22 may determine the dimming state of each of the other lighting fixtures 20 by receiving the dimming state of each of the lighting fixtures 20 via a mesh network that includes the plurality of lighting fixtures 20. Furthermore, lighting system 10 may include a device that obtains the dimming state of each of the plurality of lighting fixtures 20, and controller 22 may determine the dimming states of the other lighting fixtures 20 based on the dimming state of each of the plurality of lighting fixtures 20 obtained from the device.

### [Advantageous Effects, Etc.]

Hereinafter, the techniques disclosed in the present specification will be described together with the advantageous effects of the techniques disclosed.

Technique 1 is lighting fixture 20 that is one of a plurality of lighting fixtures 20 each of which emits light in a different one of a plurality of areas 40 included in a space, and lighting fixture 20 includes: light source 24; communicator 21 that receives (i) a first detection signal indicating that a person is detected in a target area that is a target to be illuminated by the light of lighting fixture 20 and (ii) a second detection signal, among a plurality of second detection signals, indicating that a person is detected in area 40 other than the target area among the plurality of areas 40; and controller 22 that (a) controls light source 24 in a first dimming state when the first detection signal is received, and (b) maintains the first dimming state when, in a case where all of the plurality of lighting fixtures 20 are in the first dimming state, a second detection signal, among the plurality of second detection signals, indicating that a person is detected in a first area other than the target area is received, and, during a most recent predetermined period, a second detection signal, among the plurality of second detection signals, indicating that a person is detected in a second area other than the first area is received.

In such lighting fixtures 20, when the user continues to move or when a plurality of users are present in the indoor space, since the entire indoor space is maintained in a bright state, the user can feel safe while the user is active in the indoor space.

Technique 2 is lighting fixture 20 according to technique 1, in which, when all of the plurality of lighting fixtures 20 are in a second dimming state or an off state, controller 22 controls light source 24 in the first dimming state regardless of whether the first detection signal or one of the plurality of second detection signals is received, the second dimming state being darker than the first dimming state.

In such lighting fixtures 20, if a person is detected when all of lighting fixtures 20 are in the second dimming state or the off state, all of lighting fixtures 20 are then controlled in the first dimming state. Consequently, since an entirety of the indoor space is made to be bright, the user can feel safe while the user is active in the indoor space.

Technique 3 is lighting fixture 20 according to technique 1 or technique 2, in which, when all of the plurality of lighting fixtures 20 are in the first dimming state, the second detection signal indicating that a person is detected in the first area is received, and the second detection signal indicating that a person is detected in the first area is an only signal received during the most recent predetermined period, controller 22 controls light source 24 in a second dimming state or an off state, the second dimming state being darker than the first dimming state.

In such lighting fixtures 20, when only one user that is using the indoor space is present, lighting fixtures 20 that illuminate areas in which the user is not present may be set to the second dimming state or the off state.

Technique 4 is lighting fixture 20 according to any of technique 1 to technique 3, in which the first area includes a plurality of areas 40.

In such lighting fixtures 20, when it is determined that the total number of users using the indoor space is less than or equal to a predetermined total number of the plurality of areas, the lighting fixtures 20 that illuminate areas in which the users are not present may be prevented from being maintained in the first dimming state.

Technique 5 is lighting fixture 20 according to any of technique 1 to technique 4, in which, when a second detection signal, among the plurality of second detection signals, indicating that a person is detected in an area in a vicinity of the target area is received, controller 22 controls light source 24 in the first dimming state.

In such lighting fixtures 20, control is performed such that the lighting fixture 20, which illuminates an area adjacent to the area in which the person is present, emits light in the first dimming state, and when the user remains in a given area, a vicinity of the given area is also illuminated. Consequently, the user can feel safe while the user is active in the indoor space.

Technique 6 is lighting system 10 that includes: a plurality of lighting fixtures 20 each of which is lighting fixture 20 according to any one of technique 1 to technique 5; and a plurality of sensors 30 that each detect whether a person is present.

In such a lighting system 10, when sensor 30 detects that the user continues to move or that a plurality of users are present in the indoor space, or the like, since all of lighting fixtures 20 are maintained to be in a brightly illuminated state, the user can feel safe while the user is active in the indoor space.

### OTHER EMBODIMENTS

While the lighting fixture and the lighting system according to the present disclosure have been described above based on the embodiments, the present disclosure is not limited to these embodiments. Forms obtained by various modifications to the embodiments that may be conceived by a person of ordinary skill in the art or separate forms obtained by combining a portion of elements in different embodiments, for as long as they do not depart from the essence of the present disclosure, may also be included within the scope of the present disclosure.

Furthermore, in the above embodiments, the lighting system is implemented by a plurality of devices. In this manner, the “system” as described in the present specification may be implemented by a plurality of devices, and may be implemented by a single device. When the system includes a plurality of devices, the elements (in particular, the functional elements) included in the system may be assigned in any manner to a plurality of devices.

Furthermore, the communication method used between devices in the above-mentioned embodiments is not particularly limited. Furthermore, communication between the devices may be relayed through a relay device (broadband router or the like) that is not shown in the figures.

Furthermore, in the above-mentioned embodiments, processes to be executed by a certain processor may be performed by another processor. Furthermore, the order of the plurality of processes may be changed, and the plurality of processes may be executed in parallel with each other.

Furthermore, in the above embodiments, each element may be implemented by executing a software program suitable for each element. Each element may be implemented by a program executing component, such as a CPU or a processor, reading out and executing a software program stored in a storage medium, such as a hard disk or semiconductor memory or the like.

Furthermore, each element may be implemented as hardware. For example, each element may be a circuit (or an integrated circuit). Such circuits may be consolidated as a single circuit, and may be configured as individual circuits. Furthermore, such circuits may each be a general-purpose circuit or a dedicated circuit.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting fixture that is one of a plurality of lighting fixtures each of which emits light in a different one of a plurality of areas included in a space, the lighting fixture comprising:
a light source;
a communicator that receives (i) a first detection signal indicating that a person is detected in a target area that is a target to be illuminated by the light of the lighting fixture and (ii) a second detection signal, among a plurality of second detection signals, indicating that a person is detected in an area other than the target area among the plurality of areas; and
a controller that (a) controls the light source in a first dimming state when the first detection signal is received, and (b) maintains the first dimming state when, in a case where all of the plurality of lighting fixtures are in the first dimming state, a second detection signal, among the plurality of second detection signals, indicating that a person is detected in a first area other than the target area is received, and, during a most recent predetermined period, a second detection signal, among the plurality of second detection signals, indicating that a person is detected in a second area other than the first area is received.

2. The lighting fixture according to claim 1, wherein
when all of the plurality of lighting fixtures are in a second dimming state or an off state, the controller controls the light source in the first dimming state regardless of whether the first detection signal or one of the plurality of second detection signals is received, the second dimming state being darker than the first dimming state.

3. The lighting fixture according to claim 1, wherein
when all of the plurality of lighting fixtures are in the first dimming state, the second detection signal indicating that a person is detected in the first area is received, and the second detection signal indicating that a person is detected in the first area is an only signal received during the most recent predetermined period, the controller controls the light source in a second dimming state or an off state, the second dimming state being darker than the first dimming state.

4. The lighting fixture according to claim 1, wherein
the first area includes a plurality of areas.

5. The lighting fixture according to claim 1, wherein
when a second detection signal, among the plurality of second detection signals, indicating that a person is detected in an area in a vicinity of the target area is received, the controller controls the light source in the first dimming state.

6. A lighting system comprising:
a plurality of lighting fixtures each of which is the lighting fixture according to claim 1; and
a plurality of sensors that each detect whether a person is present.
